(19) United States
(12) Patent Application Publication
(10) Pub. No.: US 2007/0228674 A1
(43) Pub. Date: Oct. 4, 2007

(54) CHUCK ASSEMBLY

(76) Inventors: Donald J. Wrobel, Traverse City, MI (US); Alex R. Chizmadia, Warren, MI (US)

Correspondence Address: DOBRUSIN & THENNISCH PC, 29 W LAWRENCE ST, SUITE 210, PONTIAC, MI, 48342, US

(21) Appl. No.: 11/679,603

(22) Filed: Feb. 27, 2007

Related U.S. Application Data
(60) Provisional application No. 60/783,589, filed on Mar. 16, 2006.

(51) Int. Cl. B23B 31/00

(52) U.S. Cl. 279/139

(57) ABSTRACT

The present invention provides an improved chuck having an engagement feature for positively locating and securing work engaging jaws on a chuck assembly, such as a diaphragm chuck assembly. In another aspect, the improved chuck also provides a quick change feature for rapid and improved mounting of the work engaging jaws to the chuck assembly.

### CLAIM OF PRIORITY

This application claims the benefit of the filing date of U.S. Provisional Application No. 60/783,589 filed Mar. 16, 2006, the contents of which are entirely incorporated by reference for all purposes.

### FIELD OF THE INVENTION

The present invention relates generally to a power chuck assembly, which is typically used for securing a work piece during machining of the same. More specifically, in one application, the present invention relates to an improved diaphragm chuck having an improved mounting surface for work engaging jaws and quick-change feature for timely and accurate changing of the same.

### BACKGROUND

Chuck assemblies are often used for engaging a work piece during machining of the same. Of the available chucks for machining components, diaphragm chucks are commonly used. These chucks function by deflecting the face of a diaphragm, either away or towards the chuck body, to engage or disengage a work piece. The diaphragm chuck generally includes a plurality of work engaging jaws that are mounted to the diaphragm about an axis of rotation and more preferably at a specific distance and angle with respect to the chuck axis. Diaphragm chucks function through the use of an actuator attached or otherwise configured to engage the diaphragm of the chuck. As the actuator applies a force against the diaphragm, in a direction along the chuck axis and away or towards the chuck, the diaphragm deflects to disengage and/or engage a work piece.

While these chucks may provide the ability to securely attach a work piece to a chuck, disadvantages exist in the ability to change the work engaging jaws for receiving different type, sized or shaped work pieces. Such disadvantageous includes tedious removal and attachment of each replacement jaw including placement and alignment of the jaws at a particular distance and angle with respect to the chuck axis. Additionally, other adjustments, such as adjustment of engaging teeth or otherwise, may be required to insure proper engagement with a work piece, particularly when engaging gears of a work piece.

Another issue relating to diaphragm chucks is the required positive engagement of the chuck jaws with the chuck body or diaphragm, to prevent movement of the jaws during machining. It is imperative that the chuck jaws be positively located on the chuck such that upon rotation, movement or machining of the engaged work piece, the chuck jaws do not move (as a result of the tool force, centrifugal force or otherwise) with respect to the surface of the chuck body or diaphragm. While some prior chuck assemblies have achieved positive engagement, they have come at the cost of complex chuck designs.

The above problems are increased when the chuck assembly is used in a machining plant specializing in the machining of a low volume parts, per job. In these situations, the chucks are constantly modified with different chuck jaw configurations to conform to the different sized and/or shaped parts for each job. This constant modification results in downtime of the machine, which results in reduced machining capacity. Accordingly, there is a direct correlation between the downtime of a chuck, due to the time required to change the jaws, and the ability to form parts and hence profits.

In view of the foregoing, there is a need for an improved chuck assembly which is configured for quick change of the work engaging jaws. More specifically, in one aspect, there is a need for a diaphragm chuck having one or more mounting features for positively locating and securing chuck jaws to the diaphragm of the chuck without substantial downtime typically encountered with prior diaphragm chuck assemblies.

### SUMMARY OF THE INVENTION

The present invention overcomes the shortcomings of the prior art by providing a chuck including a positive engagement feature (e.g. footprint as described herein), for engagement with a chuck jaw. In doing so, the chuck is capable of positively locating the jaws with respect to the chuck axis and provides an improved mounting surface which further provides substantial resistance to movement of the chuck jaw with respect to the surface of the chuck. Furthermore, this positive engagement reduces the time required to replace the chuck jaws.

In one aspect, the present invention provides a diaphragm chuck assembly including a chuck body adapted for rotation about an axis and a diaphragm mounted to the chuck body, the diaphragm including a plurality of mounting structures attached or formed on an exterior surface of the diaphragm and radially disposed with respect to the axis. The diaphragm chuck also includes an actuator adapted for engagement with the diaphragm, the actuator being configured for movement along the axis and between an engagement position and disengagement position. The diaphragm chuck further includes work engaging jaws removably attached to the plurality of mounting structures, wherein the mounting structures and work engaging jaws include corresponding gears or teeth adapted to locate and secure the work engaging jaws to the diaphragm, and wherein upon axial movement of the actuator the central portion of the diaphragm moves inward or outward with respect to the chuck body thereby causing the work engaging jaws to engage and/or disengage a work piece.

The present invention also provides a quick-change chuck jaw features for securing the jaws of the chuck to the diaphragm assembly. This quick-change features reduces the required time to secure the jaws of a chuck to the chuck body after placement thereon.

In one aspect, the quick change feature comprises a cam configuration formed between the jaws and the chuck assembly. The cammed configuration may include a dual stage cammed action formed of cammed surfaces having different angular degrees with respect to each other. On one example the cam configuration includes: i) a rotatable threaded member mounted within a chuck assembly; ii) a bar member axially movable within the chuck assembly, the bar member including corresponding threads to the rotatable member, the bar member including one or more cammed surfaces; iii) a drive member axially movable within the chuck assembly, the drive member including one or more cammed surfaces configured to engage the cammed surfaces of the bar member at a first end and configured to engage one of the work engaging jaws at a second end, wherein upon rotation of the treaded member the bar member axially moves to cause engagement of the cammed surfaces and axially move the drive member and cause locking of the work engaging jaw to the diaphragm.

In another aspect, the quick change feature comprises a threaded mounting configuration formed between the jaws and the chuck assembly. In one example, the threaded configuration includes a threaded collar configured to engage threads formed about a mounting structure of a chuck assembly. The threaded collar is configured to engage one of the work engaging jaws, wherein upon rotation of the collar engages the work engaging jaws and locks the jaw to the diaphragm.

It should be appreciated that the above referenced aspects and examples are non-limiting as others exists with the present invention, as shown and described herein. Also, any of the above mentioned aspects or features of the invention may be combined to form other unique configurations, as described herein, demonstrated in the drawings, or otherwise.

### DESCRIPTION OF THE DRAWINGS

FIG. 1 illustrates an exploded perspective view of one embodiment of a diaphragm chuck assembly according to the teachings of the present invention.

FIG. 2 illustrates another exploded perspective view of the diaphragm chuck assembly shown in FIG. 1.

FIG. 3A illustrates an assembled top view of the diaphragm chuck assembly shown in FIG. 1.

FIG. 3B illustrates a cross-sectional view of the diaphragm chuck assembly shown in FIG. 3A.

FIG. 4A illustrates a top view of the diaphragm for the diaphragm chuck assembly shown in FIG. 3A.

FIG. 4B illustrates a cross-sectional view of the diaphragm shown in FIG. 4A.

FIG. 5A illustrates a top view of the counter-weight for the diaphragm chuck assembly shown in FIG. 4A.

FIG. 5B illustrates a cross-sectional view of the counter-weight shown in FIG. 5A.

FIG. 6A illustrates a top view of the back plate for the diaphragm chuck assembly shown in FIG. 3A.

FIG. 6B illustrates a cross-sectional view of the back plate shown in FIG. 6A.

FIG. 7 illustrates an alternate configuration of the diaphragm chuck assembly shown in FIG. 3A.

FIG. 8A illustrates the first mounting configuration for the diaphragm chuck assembly shown in FIG. 3A.

FIG. 8B illustrates a cross-sectional view of the first mounting configuration shown in FIG. 8A.

FIG. 9A and 9B illustrates an exemplary embodiment of a second mounting configuration for the chuck jaws of a diaphragm chuck assembly according to the teachings of the present invention.

FIG. 10 illustrates an exploded perspective of the jaw clamping mechanism for the second mounting configuration.

FIGS. 11A and 11B illustrate progressive views of mounting and securing of a chuck jaw to the diaphragm chuck assembly with the second mounting configuration.

FIG. 12 illustrates an exploded perspective view of an exemplary embodiment of a third mounting configuration for the chuck jaws of a diaphragm chuck assembly according to the teachings of the present invention.

FIG. 13 illustrates another exploded perspective view of the third mounting configuration shown in FIG. 12.

FIG. 14 illustrates a cross-sectional view of the third mounting configuration shown in FIG. 12.

FIGS. 15A and 15B illustrate progressive views of mounting and securing of a chuck jaw to the diaphragm chuck assembly with the third mounting configuration.

### DETAILED DESCRIPTION OF THE INVENTION

The present invention provides a diaphragm chuck assembly having an improved mounting configuration and quick change system for changing work engaging chuck jaws. The mounting configuration of the present invention provides a secure mounting surface for positively locating, and mounting of similar or different chuck jaws. This allows for rapid changing of similar or different jaw configurations for engaging different work pieces (e.g., type, size, shape or otherwise). Further, the chuck jaws may be configured for engagement with work pieces having outwards facing surface or gears, inwardly facing surface or gears, or both. Other configurations will be appreciated, as described herein, or otherwise.

One particularly unique feature of the present invention is the mounting configuration which allows for each of the chuck jaws to be precisely placed onto the chuck body in substantially a single step. The mounting configuration includes one or more engagement features adapted to positively locate and resist movement (e.g. rotational, radial, axial or otherwise) of the chuck jaws with respect to the chuck axis. Preferably, the mounting configuration or structure includes a locating feature (e.g. a pin, or other alignment feature) that may be used in conjunction with the engagement feature to assist in aligning the jaws with engagement feature. By providing the ability to positively locate the jaws on the chuck body in substantially a single step or few steps, the jaws can be repeatedly replaced without substantial down time that is typically required for aligning the work piece engagement features of the jaws with the chuck axis.

In one particularly useful application, the engagement feature of the present invention may be used with a diaphragm chuck. As known in the art, diaphragm chucks include a flexible member (e.g. a diaphragm) configured for elastic deformation along the chuck axis. As the diaphragm is flexed, either outwardly or inwardly, the work piece engagement features of the jaws either engage or release the work piece depending on the engagement configuration with the work piece.

Yet another unique feature of the present invention is the mounting arrangement of the chuck jaws with the engagement feature. The present invention further provides quick-change mounting arrangement for maintaining the position of the chuck jaws with respect to the engagement feature. This quick-change, which may be used with diaphragm or other chuck, provides a further reduction in necessary time for replacement of chuck jaws.

Other advantages of the present invention will be appreciated as shown and described herein. Furthermore, the following description of embodiments and configurations of the present invention are non-limiting as other embodiments and configurations are available and within the scope of the present invention.

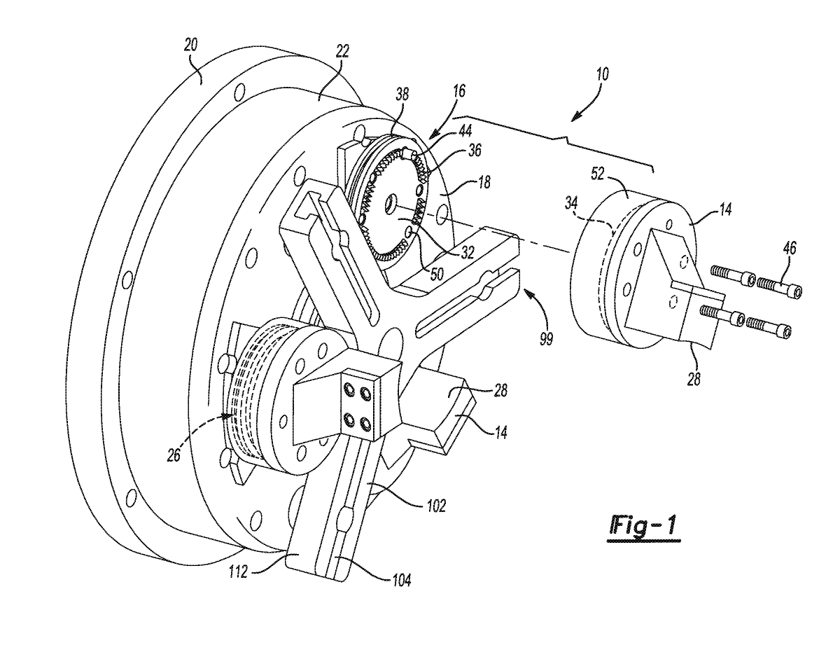

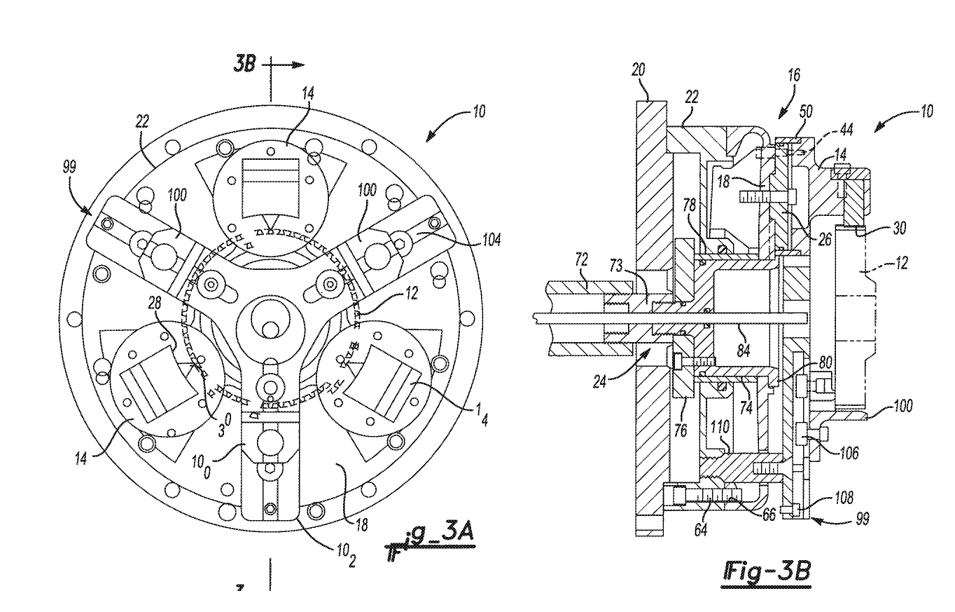

Referring to FIGS. 1, 3A and 3B, one configuration of a substantially complete chuck assembly 10 of the present invention is shown. In this embodiment, the chuck assembly comprises a diaphragm adapted to engage and disengage a work piece 12 through the use of one or more and preferably a plurality (e.g. 3, 4, 5, 6, etc.) of work piece engaging jaws 14. The diaphragm chuck includes a diaphragm assembly 16 having a diaphragm 18 (e.g., a flexible resilient shell like member, or the like). The diaphragm is mounted to the chuck body 20, via back plate 22, about an outer periphery edge through a plurality of fasteners. The diaphragm is configured for deflection at an interior portion, via an actuator assembly 24. As the diaphragm deflects outwardly and/or inwardly the work piece engaging jaws engages or disengages a work piece, depending on whether the engagement is on an outer portion or interior portion of the work piece.

The chuck assembly includes one or more positive engagement feature or assembly 26 for receiving and locating the work engaging jaws 14 onto the diaphragm. The positive engagement assembly includes features or is configured to precisely locate the jaws onto the diaphragm, or otherwise, such that the jaws are positioned and oriented, with respect to the axis of the chuck, for engagement with a work piece 12. In precisely locating each jaw onto the diaphragm of the chuck assembly, it is possible to replace the jaws of the chuck without having to align the jaws with respect to the chuck axis. Accordingly, numerous jaws can be designed based upon the known point of connection and positive engagement of the jaws with the chuck and more specifically the chuck axis.

The positive engagement assembly also includes (or is configured with) one or more features that prevent or substantially limit movement of the jaws during machining of the work piece in which the jaws are engaged with. Accordingly, the positive engagement assembly acts to both locate the jaws onto the chuck assembly but also prevent the same from movement during machining of a work piece. In one preferred configuration, the locating feature and the movement limiting feature comprises the same component or otherwise is included within the same assembly.

The chuck assembly is configured for receiving numerous types of work engaging jaws 14 having similar or different work piece engagement features. For example, the jaws may include an inwardly facing engagement portion 28 for engaging the exterior of the work piece. Alternatively, the jaws may include outwardly engaging portion for engaging the interior of the work piece. Still further, the jaws may include both inwardly facing and outwardly facing engaging portions for a work piece. In other words, the jaws may be used for outside diameter clamping, inside diameter clamping, or both. In any of the configurations, the engaging portions 28 may include one or more contoured portions for engaging certain portions or types of work pieces. For example, the contoured portions may comprise a ball, tooth or otherwise 30 for engaging gears of a work piece. Also, it is contemplated that these contoured portions, or other portions of the jaws may be adjustable or replaceable. However, in one preferred configuration, the features of the jaws are fixed such that the jaw is placed and mounted to the chuck assembly without further necessary adjustment.

Referring again to the positive engagement assembly 26, the assembly includes corresponding positive engagement features 32, 34 located on or formed with the diaphragm 18 and jaw 14, respectively. The engagement features may include one or more, and in at least one configuration a plurality of, individual locators that act together to locate the jaws onto the diaphragm and prevent movement of the jaws.

The engagement features may be formed of any suitable engagement feature which positively locates and secures the components together. Preferably, a joint is formed by the engagement feature. The engagement feature may comprise a plurality of male and female components configured to join together. In one preferred configuration, the engagement features of the chuck and the jaws comprise teeth or gears 36 to form a meshing relationship which locates the jaw and also substantially limits and/or prevents movement of the jaw during machining.

In one preferred configuration, the engagement features 32, 34 form footprints on the diaphragm and jaws, respectively. The corresponding footprints may be formed of irregular or regular shapes e.g. circular, elliptical, square or rectangular, or otherwise. Also, the corresponding footprint may comprise one or more linear arrangement, arcuate arrangement, or combinations thereof. However, in one preferred configuration, the footprints formed by the engagement features of the chuck and jaws are circular in shape and form a meshing relationship when joined together. Other configurations should be appreciated.

Optionally, the engagement feature of the diaphragm may be formed on a separate component which is further attached to the diaphragm. This may be particularly advantageous for reducing manufacturing cost. For example, an additional mounting structure 38 may be provided for attachment to the diaphragm and which is formed with the positive engagement feature for the diaphragm. It should be appreciated that in this configuration, the positive engagement features of the diaphragm (e.g. footprints, teeth, etc.) are located on the additional mounting structure and configured to engage jaw 14.

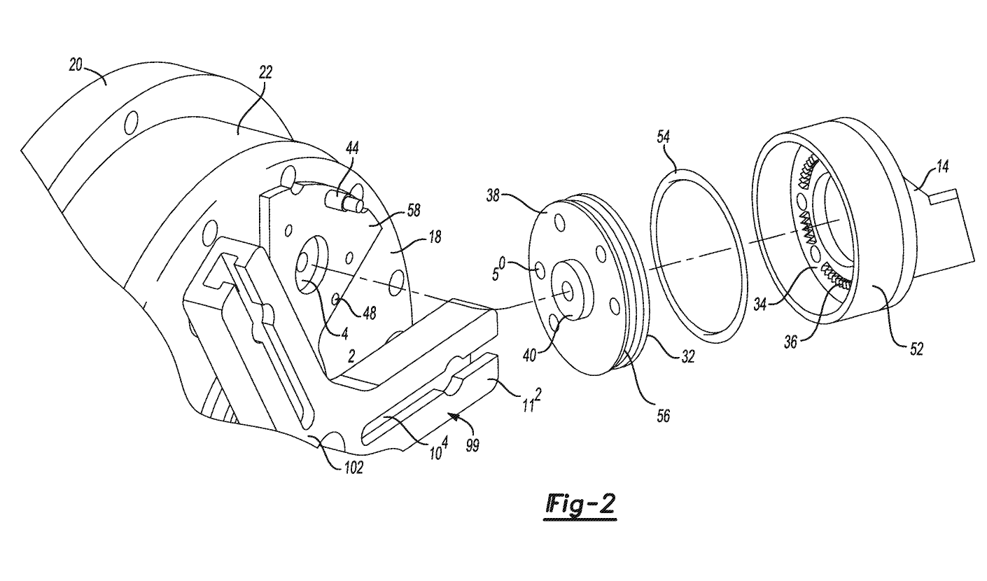

The additional mounting structure 38 includes an engagement feature 40 configured for engagement with a corresponding engagement feature 42 formed by the diaphragm. In the configuration shown on FIG. 2, the engagement features 40, 42 comprises one or more male and female members formed opposite the footprint and one or more corresponding male or female member formed by the diaphragm. In one preferred configuration, the engagement feature of the additional mounting structure is located centrally and comprises a male member extending from the side opposite the footprint. The male and female members may be sized (with suitable tolerances) such that upon engagement there is little to substantially no lateral movement between the additional mounting structure and the diaphragm. Optionally, a fastener may be used to secure (and optionally further align) the additional mounting structure to the diaphragm.

The engagement assembly 26 may include an alignment feature for aligning the first and second engagement features during joining of the same. In one configuration, the alignment feature comprises a pin 44 extending from the first engagement feature of the diaphragm (or alternatively from the jaw) that extends into a hole formed in the first engagement feature of the jaw. Of course, other configurations are contemplated, such as those described herein, particularly with respect to the quick-change features described herein.

The jaws 14 are secured to the diaphragm through one or more means as described herein. As shown in FIGS. 1 and 2, this may comprise a plurality fasteners 46 extending through the jaws and engaging holes 48 formed in the diaphragm, or otherwise. Also, when an additional mounting structure 38 is used, the additional mounting structure may include through holes (or threaded holes) 50 for allowing fasteners 46 to extend therethrough. However, as described further herein, other means are available that may be used with the fastening system or alone. In particular, the present invention provides additional means comprising a quick-change feature for quickly securing and releasing the jaws from the chuck.

Optionally, the chuck assembly may include a sealing means for preventing or substantially limiting material (from the surrounding environment, work piece or otherwise) from entering the positive engagement assembly. In one configuration, referring to FIGS. 1, 2, 3B, the sealing means is formed of a sleeve 52 surrounding the positive engagement feature of the jaw and the diaphragm (e.g. additional mounting structure 38). In this configuration, the sleeve is mounted to the jaw (via a press fit or otherwise) and is in sealing engagement with the additional mounting structure through seal 54, which resides in a groove 56 formed about the additional mounting structure.

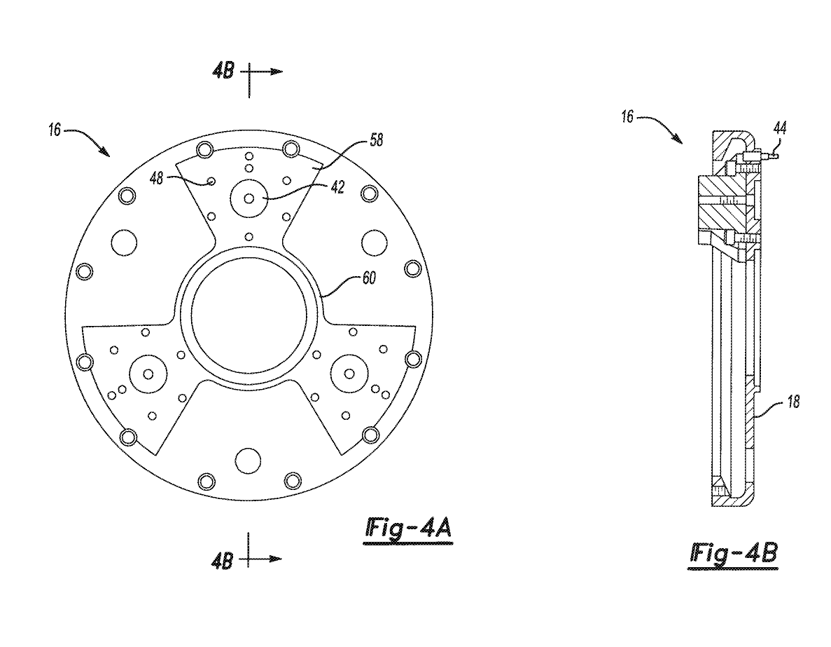

It is contemplated that the chuck assembly may include additional features for improving performance of the chuck assembly. For example, referring to FIGS. 2, 4A and 4B, the diaphragm may include one or more stiffening features providing additional mounting structure and/or improving the resilience and/or stiffness of the diaphragm. In this configuration, the stiffening feature comprises one or more raised portion 58 (preferably equal to the number of jaws) extending about at least a portion of the diaphragm. The raised portions are configured for engagement (and includes engagement feature 42) with the additional mounting structure 38 and further includes threaded holes 48 for receiving the mounting fasteners extending through the jaws. In one preferred configuration, the stiffening feature further includes a ring 60 extending about the chuck axis for providing further increased stiffness.

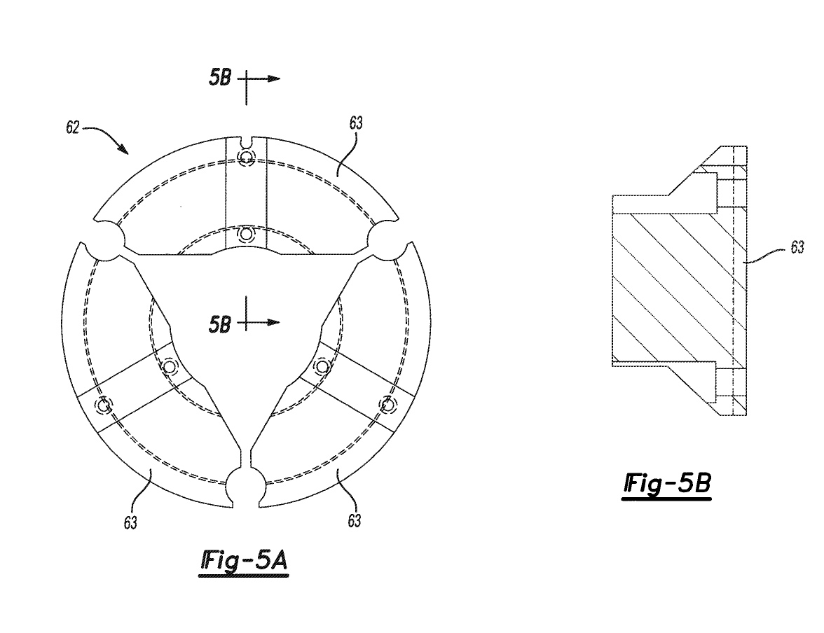

Another additional feature of the chuck assembly includes means for stabilizing the chuck assembly during rotation and machining of the work piece. For example, referring to FIGS. 4B, 5A and 5B, the chuck assembly may further include a counterweight assembly 62 integrated or mounted to the chuck assembly or more particularly the diaphragm. The counterweight assembly 62 is located on or adjacent the interior surface of the diaphragm and opposite the mounting structures formed on the exterior surface.

While it is contemplated that different counterweight configurations are available, in one preferred configuration, the counterweight assembly comprises a plurality of members 63 mounted or fastened to the diaphragm assembly. A counterweight may be provided for each jaw. The separation of the counterweight into a plurality of member allows the diaphragm to elastically deform without undue binding from the counterweight. Accordingly, it is contemplated that the diaphragm assembly may include one or more attachment features (mechanical fasteners or otherwise) for the attachment of the counterweight. Optionally, the counterweight may be configured for receiving a portion of an alignment or locating pin 44 used to assist in locating the jaw onto the mounting structure or diaphragm.

As previously mentioned, the diaphragm assembly 16 is mounted to the chuck body 20 and more particularly to a back plate 22. Referring to FIGS. 3B, 6A, 6B and 7, the back plate is configured with a plurality of mounting features for attachment with the diaphragm assembly. The mounting feature comprises threaded fasteners 64 engaging a plurality of threaded holes 66 formed in the diaphragm.

The back plate 22 also includes another mounting feature for attachment of the back plate to other components of the chuck body which provides rotational forces to the back plate and attached components thereto. In this configuration, the additional mounting feature also comprises threaded fasteners extending through the diaphragm and the back plate to engage the chuck body 22.

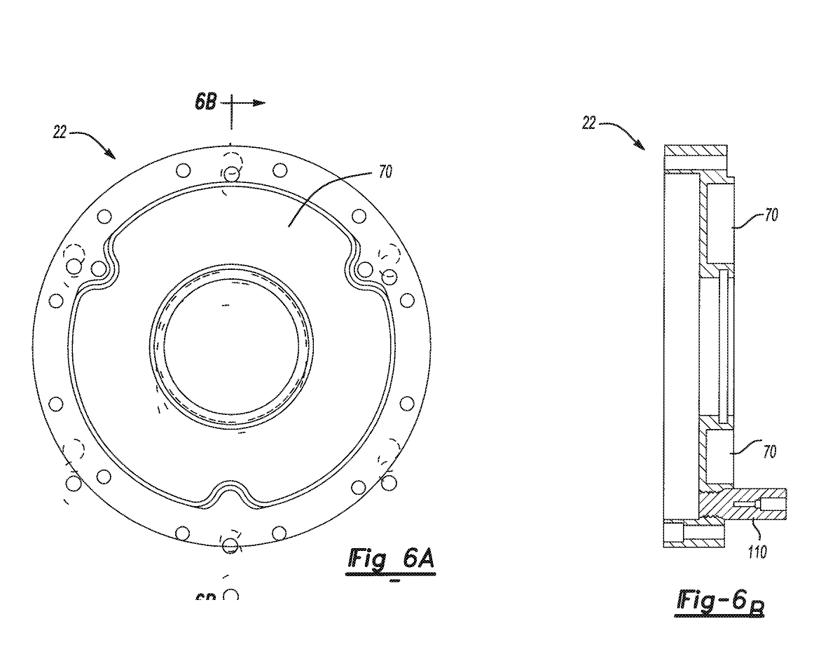

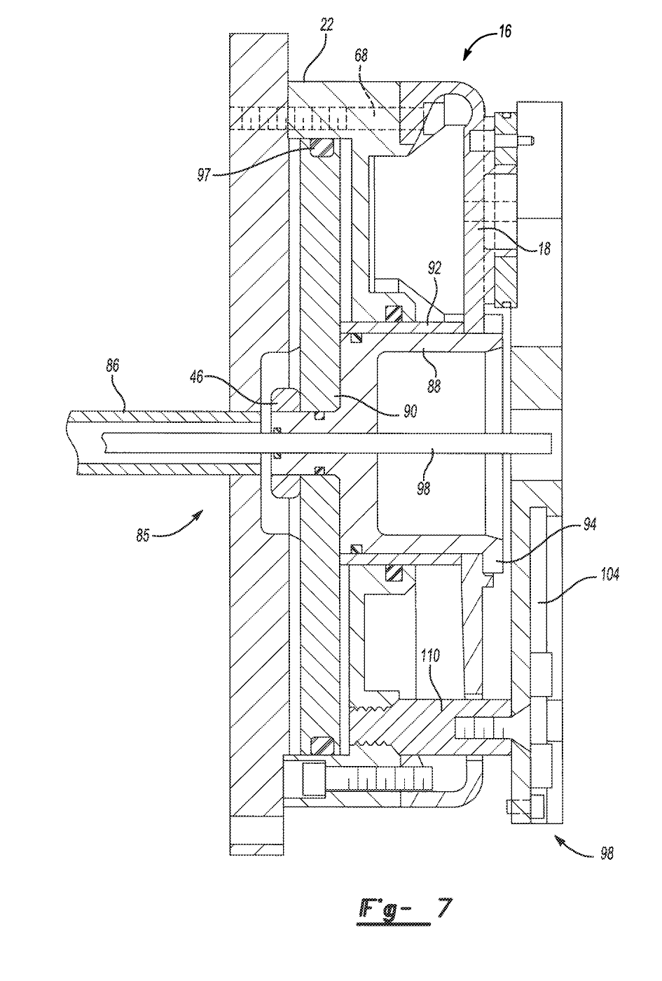

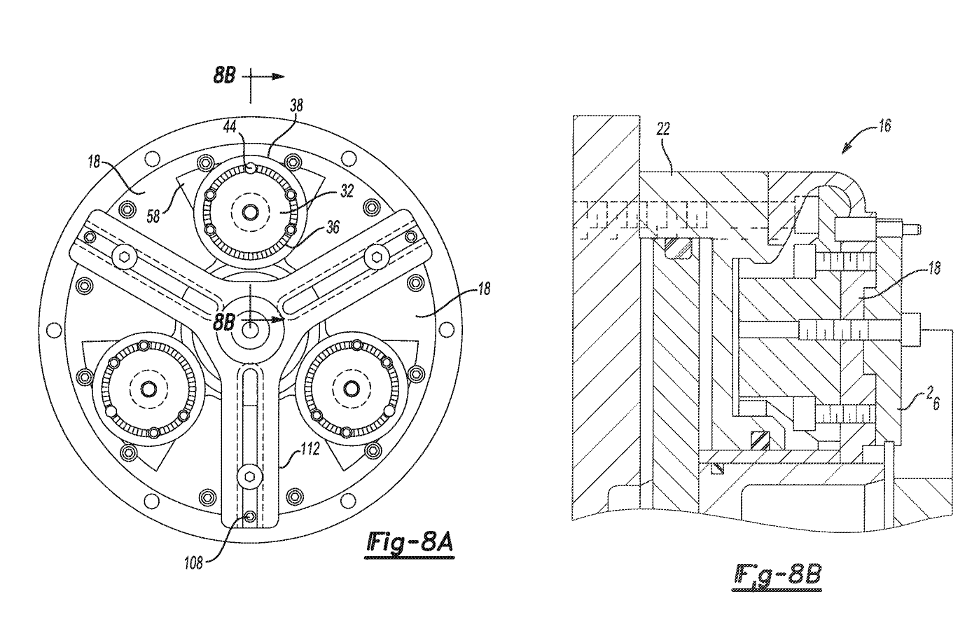

In one preferred configuration, the back plate includes one or more recesses 70 for receiving all or a portion of the counter weight assembly extending from an interior surface of the diaphragm. Preferably, the recesses are suitable in size to allow movement of the counterweight during flexing of the diaphragm without interference. The back plate may include the same number of recesses as counter weights, raised portions, mounting structures and jaws. Alternatively, a single recess may extend entirely around the chuck axis, as shown in FIG. 6A.

As previously mentioned, the chuck assembly also contemplates an actuator assembly 24 for causing extension and/or retraction of the diaphragm 18. The actuator assembly is configured for applying an axial force sufficient to deflect the diaphragm 18. While this deflection may be inwardly or outwardly, along the chuck axis, in the embodiments shown the actuator assembly is configured to create an axial force away from the chuck causing the diaphragm to extend outwardly.

Referring to FIG. 3B, one example of a suitable actuator assembly 24 is shown configured for mechanical actuation. The actuator assembly includes drawbar 72 connected to an actuating means (not shown) at a first end and indirectly to the diaphragm assembly 16 at the second end. More specifically, the drawbar is connected to an intermediary portion 73 via internally formed or externally formed threads. The intermediary portion is connected to cup member 74 (again via a threaded configuration) and a ring member 76, which is configured to trap the diaphragm 18 between a cylindrical member 78 and the cup member, through lip 80. As the draw bar extends outwardly, a force is applied to the ring member and cylindrical member, which in turn applies a suitable force for deflecting the diaphragm outwardly. Upon release, the resiliency of the diaphragm causes the diaphragm to return to an original position.

Alternatively, in another configuration, the drawbar may be configured to draw the actuator assembly inwardly to cause the diaphragm to deflect inwardly through a lip 80 formed on cup member 74. This may be done to engage or disengage a work piece, or to further secure the jaws to the work piece. Upon release of the force, again the diaphragm returns to an original position due to the resiliency of the diaphragm. It should be appreciated that the direction of force may be based upon whether the engagement feature of the jaws for engaging a work piece is inwardly facing or outwardly facing.

Optionally, the draw bar 72 is further configured with an opening for receiving a tubing 84. The tubing may be configured to provide an opening for the egress of fluid, such as air, lubricant, or otherwise, to cool and/or clean the chuck assembly during or after machining.

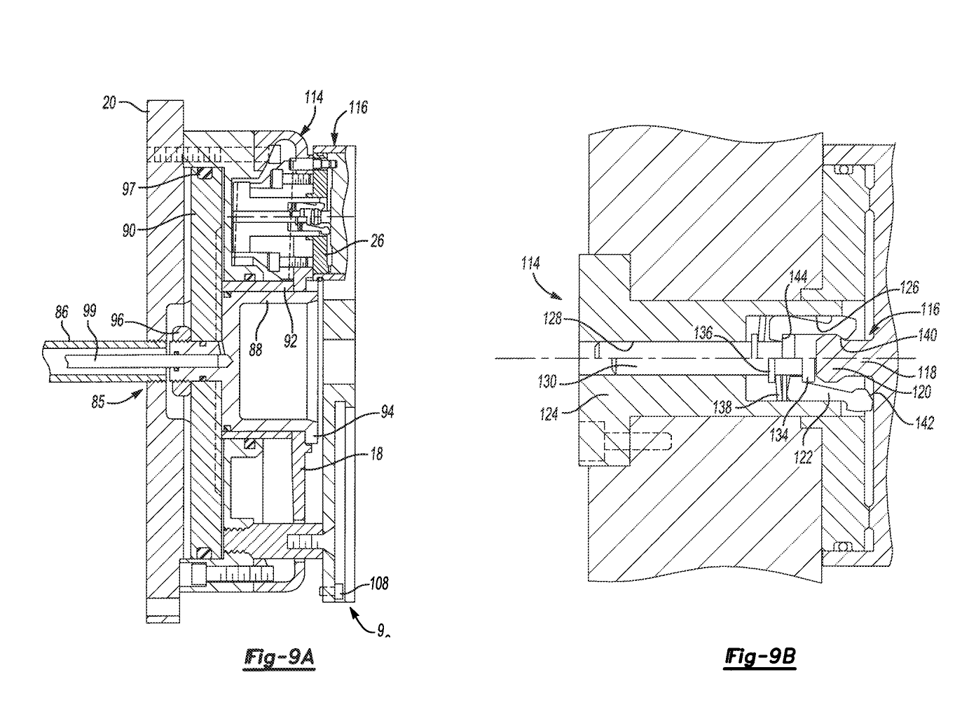

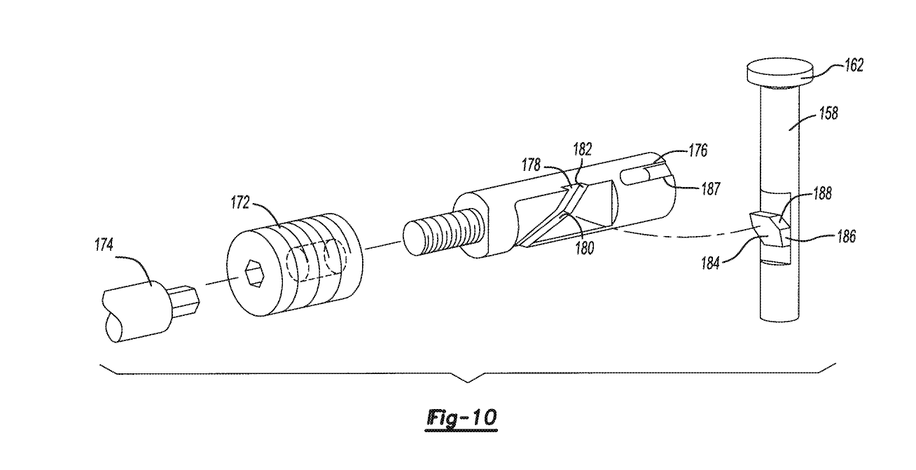

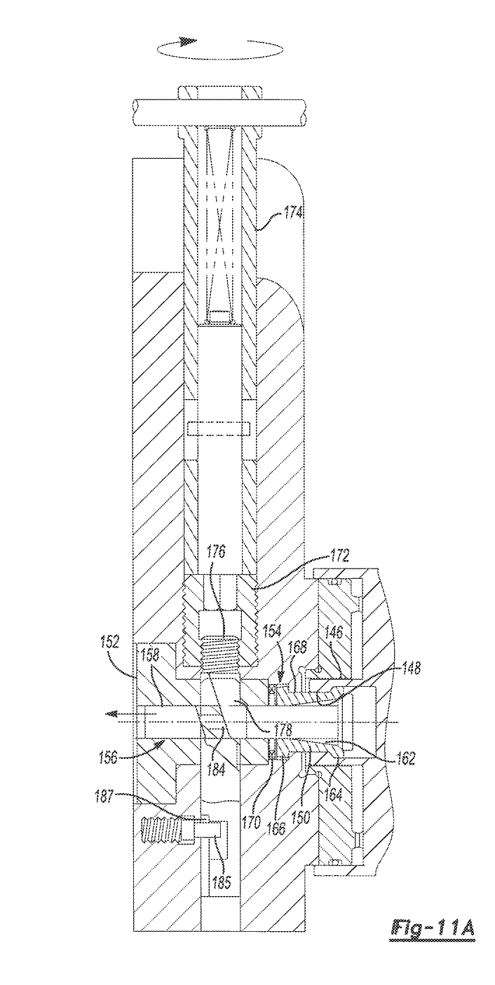

In another example, referring to FIGS. 7 and 9A, the actuator assembly 85 is configured for hydraulic or pneumatic actuation. In the embodiment shown, the actuator assembly is configured for pneumatic force; however, it should be appreciated that smaller components may be used with hydraulic configurations as this configuration may provide for increase application of force. In these configurations, the draw bar is replaced by a pipe member 86 suitable in strength for delivering pneumatic force to the actuating components. The actuator assembly includes a cup member 88 and a ring member 90, which is configured to trap the diaphragm 18 between a cylindrical member 92 and the cup member, through lip 94. The cup is also attached to the ring member via a fastener 96. The ring member is spaced apart from the chuck body 20 to form a first gap therebetween that is in fluid (e.g. liquid or air) communications with the pipe member. As fluid enters the actuating system, the gap is filled with the pressurized fluid and a force is applied to the ring member and cylindrical member, which in turn applies a suitable force for deflecting the diaphragm outwardly. A seal 97 is provided to prevent fluid from exiting the actuator assembly and/or a loss of pressure). Upon release, the resiliency of the diaphragm causes the diaphragm to return to an original position. As with the first example, optionally a tubing 98 may be provided to cooling or cleaning of the components of the chuck assembly.

Optionally, as shown in FIG. 9A, the actuator may form a second gap which is between the ring member and cup. The second gap is in fluid communications with an additional tube member 99, wherein upon fluid entering the second gap a force is applied to further draw the diaphragm inwardly thereby further engaging the jaw with the work piece.

Optionally, the chuck assembly may further include a rough part (or work piece) locator assembly for assisting in guiding the work piece between the jaws prior to gripping of the same. For example, referring to FIGS. 1, 3A, 3B and 9A, an exemplary configuration of a rough part locator assembly 99 is shown. The rough part locator includes guides 100, located opposite the jaws 14, adapted to guide the work piece therebetween. The locator assembly includes a mounting bracket 102 for allowing movement of the guides towards and/or away from the chuck axis. Preferably, the guides are adjustably mounted (via manually or otherwise) to the mounting bracket to allow movement towards or away from the chuck axis.

Optionally, the guides 100 are mounted along a grooved or slotted portion 104 through one or more fasteners 106, which may include a portion larger than the width of at least a portion of the grooved portion to prevent or limit removal of the guides from the mounting bracket. Also, one or more stops 108 may provided to limit movement of the guides within the grooved or slotted portion. These stops may be replaceable to correspond to different sized or shaped guides.

The mounting bracket is further mounted to the chuck body, via a mounting post 110 extending from the back plate. Preferably, there is an equal number of mounting post as fingers 112 extending from the mounting bracket 102 to provide stable mounting of the mounting bracket. In one configuration, the mounting platform is attached to the back plate 22 through a threaded configuration between the mounting platform and a hole formed in the back plate. Also, as should be appreciated, the mounting platform may extend through at least a portion of the diaphragm 18.

As previously mentioned, the present invention further contemplates quick-change features for expedited replacement of the jaws 14 of the chuck assembly 10. The quick-change features are configured to maintain engagement of the corresponding components of the positive engagement assembly 26. These features provide simple and effective means for securing the jaws to the chuck assembly according to any of the teachings herein, or otherwise.

In one exemplary configuration, the quick-change feature comprises or is configured with a cammed action for drawing the jaws to the chuck assembly (e.g. diaphragm or otherwise). The cammed action is configured to progressively apply a force to the jaw, or a component thereof, to draw the jaw against the diaphragm and/or apply a force to the jaw component to maintain position of the jaw during machining of a work piece.

For example, referring to FIGS. 9A-11B, several configurations of a cammed action quick-change assembly 114 are shown. In these configurations, the quick change assembly engages a quick-change engagement feature 116 of a jaw 14 to draw the same further into the chuck assembly and/or apply a force thereto to maintain position of the jaw.

In a first example, referring to FIGS. 9A and 9B, the engagement feature of the jaw includes an elongated portion 118 having an enlarged end portion 120 with a diameter greater than at least a portion of the elongated portion. The end portion of the engagement feature being configured to engage the quick-change assembly 114. The quick-change assembly includes one or more (e.g. 2, 3, 4 or more) paws 122 that are movably located within a portion of a quick-change housing 124. The housing includes a first cavity 126 for receiving the paws and the engagement feature of the jaw. The housing also includes a second cavity 128 for receiving and guiding a drive member 130.

The drive member 130 is configured for attachment to a driving means at a first end (discussed in more detail below) and engagement with the paws at a second end. The drive includes a first retaining shoulder 134 located at the second end of the drive member for engagement with the paws and a second retaining shoulder 136 spaced from the first retaining shoulder. The paws travel between the first and second retaining shoulders and may be biased by spring member 138.

The paw members includes a first end having a first inwardly projecting lip 140 for engagement with the enlarge end portion 120 of the quick-change engaging feature 116 of the jaw. The inwardly projecting lip includes a chamfered portion 142 to more easily receive the end portion of the engaging feature 116. The paw members further includes a second inwardly projecting lip 144 for engagement with the first retaining shoulder.

In operation, to receive the end portion 120 of the engagement feature 116 of the jaw, the drive 130 extends outwardly to move the paws 122 outwardly through the retaining shoulder 136. This movement causes the paws to rotate outwardly for receiving the end portion 120 of the jaw engaging feature. Once the end portion is received by the paws, the drive retracts causing the paws to rotate inwardly and engage the end portion of the jaw engagement. The drive continually moves inwardly to further draw the engagement feature into the first cavity 126 further securing the jaw to the chuck assembly.

In a second example, referring to FIGS. 11A and 11B, the engagement feature of the jaw includes a cylindrical portion 146 having an inwardly extending lip 148 configured to engage the quick change assembly 114. The quick-change assembly includes one or more (e.g. 2, 3, 4 or more) paws 150 that are movably located within a portion of a quick-change housing 152. The quick-change housing may comprise or be formed of a portion of the diaphragm or may comprise a separate component attached thereto, or a combination thereof. The housing includes a first cavity 154 for receiving the paws and the engagement feature of the jaw. The housing also includes a second cavity 156 for receiving and guiding a drive member 158.

The drive member 158 is configured for attachment to the drive means at a first end (discussed in more detail below) and engagement with the paws 150 at a second end. The drive includes a retaining shoulder 162 located at the second end of the drive member for engagement with the paws. The retaining shoulder includes a chamber for improved engagement with the paws.

The paw members includes a first end having a first outwardly projecting lip 164 for engagement with the inwardly projecting lip 148 of the quick-change engaging feature 116 of the jaw. The paw members further includes a second outwardly projecting lip 166 for engagement with the housing 152. The paws are located between a base portion of the first cavity 154 and an inwardly extending lip 168. A spring 170 is provided for maintaining the paws in an initial position, prior to application of force by the drive member 158.

In operation, to receive the cylinder 146 of the engagement feature 116 of the jaw, the drive member 158 extends outwardly to allow the paws 150 to reside in an initial inbound state. The cylindrical portion 146 of the jaw is lowered into the first cavity 154. The drive member is lower to cause the retaining shoulder 162 to contact the chamfered portion located on the inboard edge of the outwardly projecting lip 164. However, it is contemplated that they may be in continuous contact. As the drive member is continually lowered, the chamfered edges of the retaining shoulder 162 and lip 164 causes the paw 150 to rotate outwardly to engage the inwardly extending lip 148 of the jaw thereby securing the jaw to the chuck assembly. Upon release, the spring 170 moves the jaws back to their original inboard state to allow the cylinder portion 146 of the jaw to be removed.

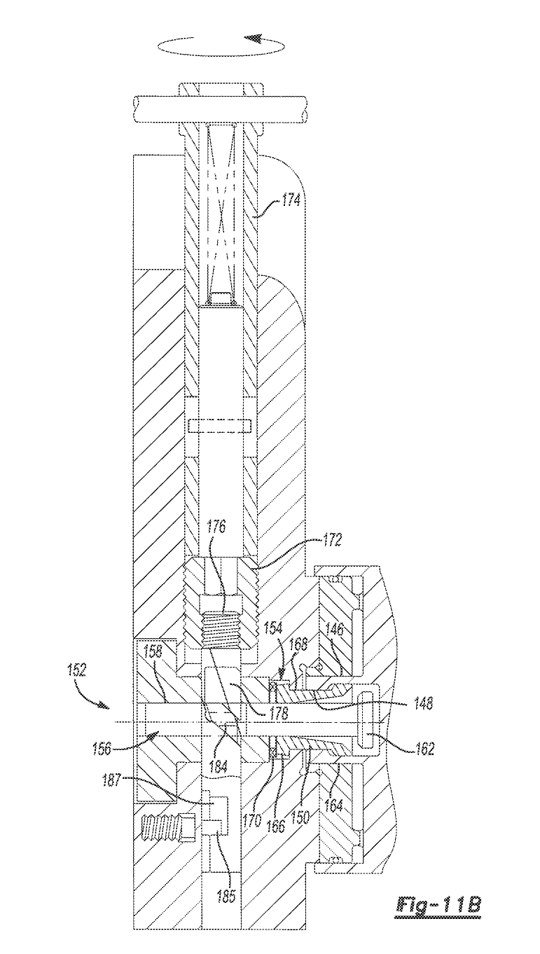

As mentioned in both of the above examples, drive members 130 and 158 are actuated through a suitable drive means. Referring to FIG. 10, and the drawings for the above two example, one exemplary drive means is shown, which includes a cammed action for causing movement of the drive members. The drive means includes a rotatable screw mechanism 172 rotatably housed by the chuck assembly (e.g. chuck body, diaphragm, quick-change housing, or otherwise). The screw mechanism includes an engagement feature, at a first end, for engaging a manual or automatic turning member 174 (e.g. lever, crank, or otherwise) extending to an external location of the chuck assembly for allowing a user to rotate the screw mechanism. The screw mechanism also includes an internal threaded configuration located at a second end for engaging a moveable member (e.g. a bar or rod like member) 176 having corresponding threads to that of the screw mechanism. Optionally, the screw mechanism may further include an external threaded configuration, which engages the chuck assembly. Preferably the external threaded configuration is in an opposite direction to the internal threaded portion. This provides increased locking speed and force.

The moveable bar member includes a cammed surface configured for acting against a corresponding cammed surface of the drive member 130, 158. The moveable bar member is moveable within a cavity or bore formed in the chuck assembly (e.g. chuck body, diaphragm, quick-change housing, or otherwise).

In one configuration, the cammed surface of the bar member 176 is formed by a groove 178 extending through at least a portion of the bar member. The bar member may include one or more cammed surfaces for providing different degrees of cammed action. For example, the bar member may include 2, 3, 4 or more cammed surfaces that are adjacently positioned or formed to create a continuous surface having varying degrees of cammed action. In one configuration, as shown in the drawings, the groove forms a dual stage cammed action for providing two degrees of cammed action. In this configuration, a first and second cammed surface 180,182 is formed, respectively.

The drive members 130, 158 includes a corresponding feature to the groove formed in the bar member. In the configuration shown, the drive members includes a projection 184 adapted to travel within the groove formed by the bar member. As with the grooved portion, the projection may also include more than one corresponding cammed surface (e.g. multiple stages). In the drawings shown, the projection includes a first cammed surface 186 for engaging the first cammed surface 180 of the groove and a second cammed 188 surface for engaging the second cammed surface 182 of the groove. While the above exemplary embodiment describes a groove formed with the bar member and a projections formed with the drive members it should be appreciated that this configuration may be reversed to form the grooved portion on the drive members and the projection on the bar member. Also, other configurations are available.

The first and second cam surfaces preferably have different degrees of cammed action. In one preferred configuration, the angular degree of the first cam surfaces are greater than the angular degree of the second cam surfaces, with respect to the axis of the bar member. In this configuration, the cam surfaces first provide a drawing speed of the drive member for bringing the corresponding engagement features of the positive engagement feature together and a second drawing speed, slower than the first, for providing a locking action for the positive engagement feature.

Optionally, the quick-change feature may further include a stop for limiting movement of the bar member. In one configuration, the limiting feature comprises a projection 185 extending in a groove 187 formed in the bar member.

In operation, upon initial placement of the jaw proximate to the quick-change assembly as described above, the turning member 174 is rotated to cause the screw mechanism 172 to rotate. The threads of the screw mechanism causes the bar member 176 to move axially causing the first cam surfaces 180, 186 of the drive member and bar member, respectively, to engage and move the drive member down further into the chuck assembly. At the end of the first cam surfaces, the second cam surfaces 182, 188 engage and further move the drive member down into the chuck assembly and lock the corresponding positive engagement features of the jaw and the chuck assembly (or diaphragm).

Optionally, a locking tool may be provided for provided for preventing the screw mechanism from rotating after securing the jaw to the chuck assembly. However, it is also contemplated that the angular configuration of the second cam surfaces may be such so as to prevent rotation of the screw mechanism and hence release of the jaw without application of force through the turning member.

In another exemplary configuration, the quick-change feature comprises or is configured with a threaded fastening action for drawing the jaws to the chuck assembly (e.g. diaphragm or otherwise). The threaded action is configured to progressively apply a force to the jaw, or a component thereof, to draw the jaw against the diaphragm and/or apply a force to the jaw component to maintain position of the jaw during machining of a work piece.

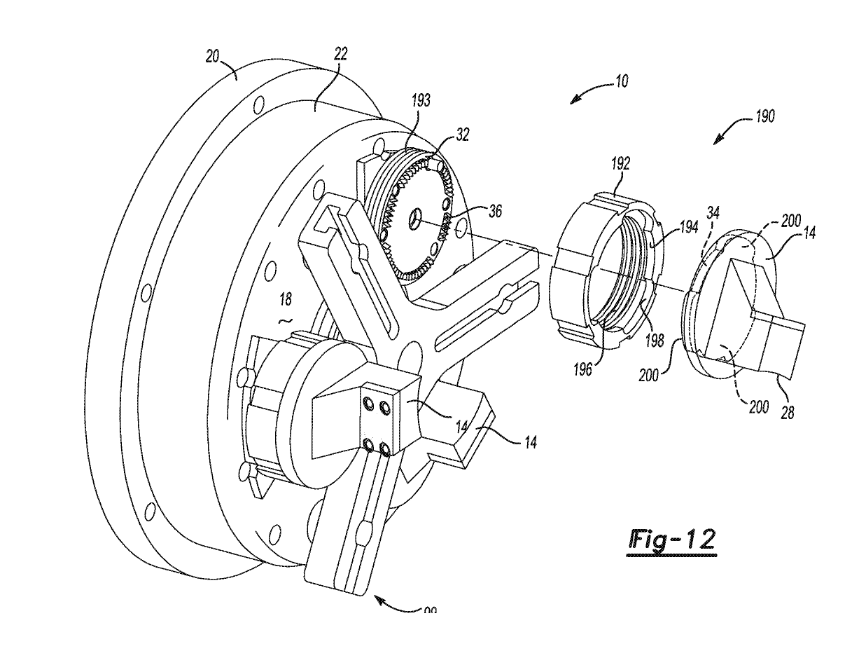

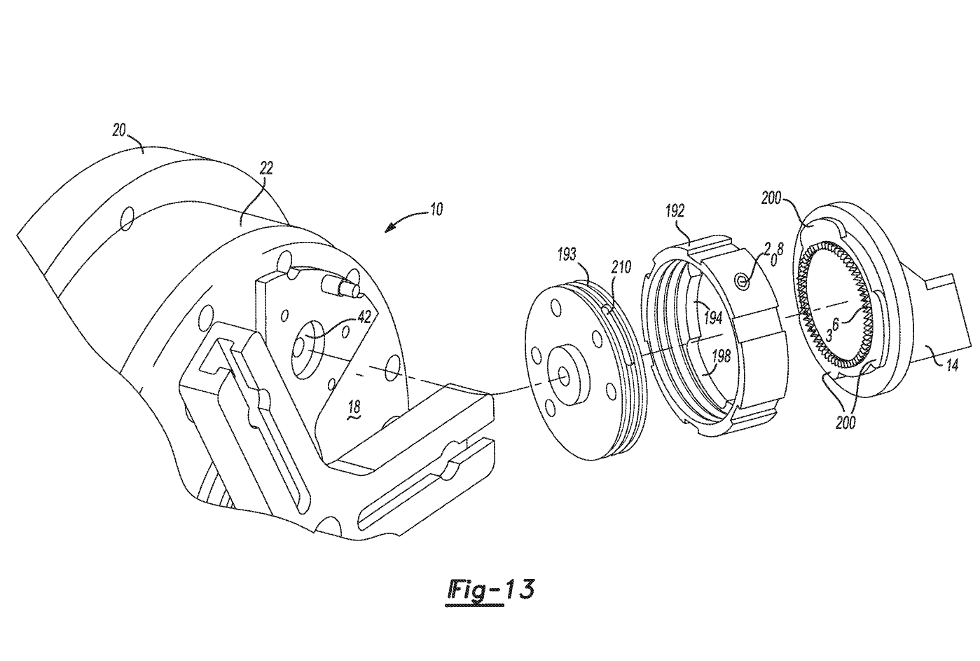

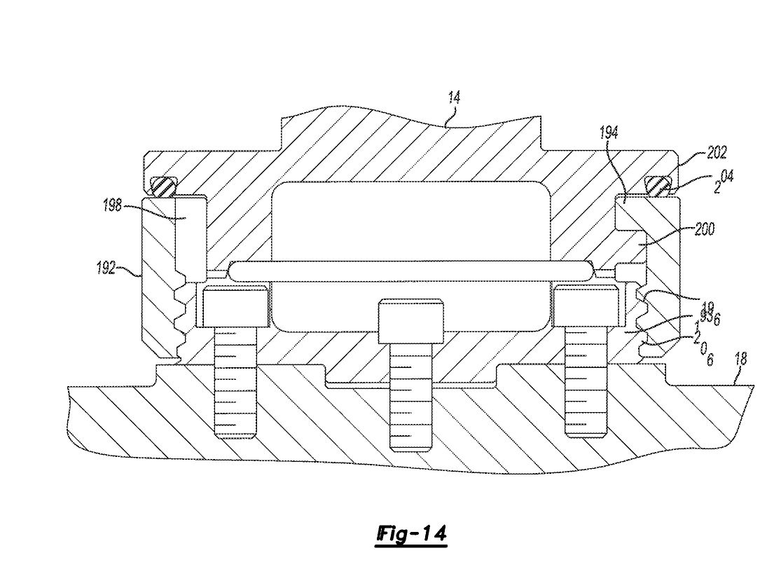

For example, referring to FIGS. 12-15B, one configuration of a threaded quick-change assembly 190 is shown. In this configuration, the quick-change assembly includes a threaded collar 192 adapted to engage the jaw 14 and a portion of the chuck assembly (e.g. diaphragm 18, additional mounting structure 193, or otherwise) to draw the jaw into the chuck assembly and/or apply a force thereto to maintain position of the jaw.

The threaded collar 192 includes a lip 194 formed on one end of the collar and threads 196 formed on an opposite end of the collar. The lip includes one or more, and preferably a plurality of (e.g. 2, 3, 4, 5, or otherwise), openings 198 formed therein for receiving a one or more lip members 200 formed on the jaw 14. Preferably, the number of lip members of the jaw corresponds to the number of openings formed on the lip member of the collar. The lip member of the jaw is preferably spaced from and edge portion 202 of the jaw. Preferably, the distance between the edge portion and the lip member is approximately equal or slightly larger than the thickness of the lip formed on collar so that the lip of the collar can fit therein. Preferably, a seal is created between the lip of the collar and the jaw. Optionally, a seal 204 may be provided for forming a seal between the collar and the jaw.

The threads of the collar are configured to engage a corresponding threaded component 206. Preferably, the corresponding threaded component surrounds the footprint formed by the positive engagement feature of the chuck assembly. In the configuration shown, the corresponding threaded component is formed on an exterior portion of the additional mounting structure, wherein the additional mounting structure is received at least partially within the collar. Of course other configurations are available.

Optionally, the collar includes a feature for controlling the amount of rotation of the collar with respect to the jaw. This feature ensures that the collar is not over tightened or under tightened such that the lip member of the collar and jaw no longer align. Furthermore, this allows the collar to rotate between a receiving position and a locking or securing position. In one configuration, the controlling feature comprises a set screw 208 configured to extend into a slot 210 formed in the additional mounting structure. In one preferred configuration, the collar is releasably mounted to the additional mounting structure and configured to rotate between a receiving position for receiving the engagement feature of the jaw and a locked position for locking the jaw against the chuck assembly.

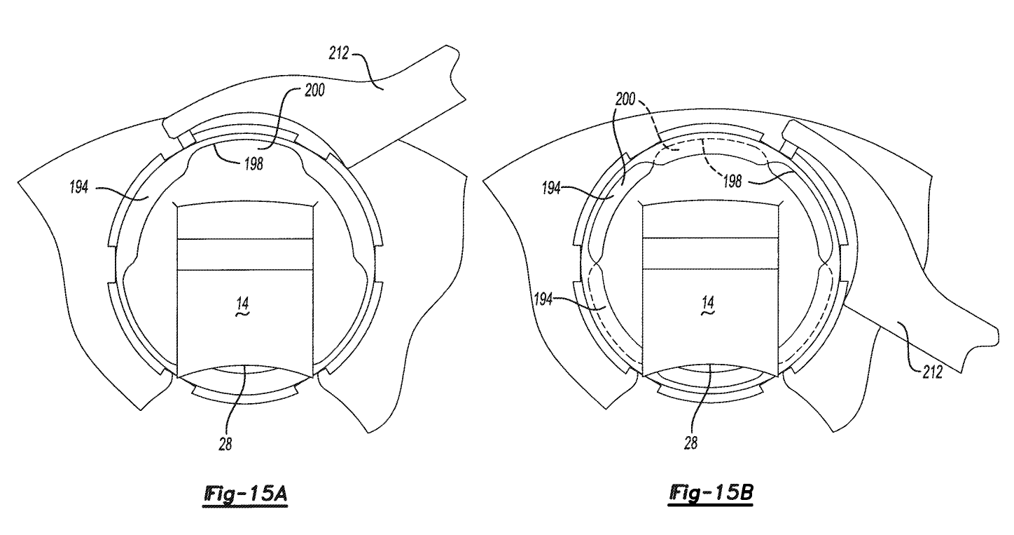

In operation, referring to FIGS. 15A, the collar is rotated to the receiving position for receiving the lip formed on the jaw. Once the corresponding positive engagement features of the chuck assembly and jaw are place together, the collar is rotated to the locked position to align the lip of the jaw and the collar. As the collar is rotated, the collar moves towards the diaphragm and/or chuck assembly to further engage and/or secure the jaw to the chuck assembly. Optionally, the rotation of the collar may be achieved through a spanner wrench 212. As the collar moves to the locked position, the seal 204 engages both the jaw and collar to prevent debris from entering the positive engagement feature during machining or otherwise. In the locked position, the friction between the collar, additional mounting structure and jaw is sufficient to prevent unlocking of the collar.

In view of the foregoing, the following comprises one operational sequence of the present invention. Upon selection of a given machining job, the jaws are selected based upon the engagement requirements between he jaws and the configuration of the work piece, such as shape, size, engagement configuration (e.g. geared or smooth), or otherwise. Each of the selected jaws is positioned over the chuck assembly such that the corresponding positive engagement features are aligned. The pin is used to more accurately align the positive engagement feature and then the corresponding engagement features are placed together, which is guided by the pin. Depending on the securing feature, e.g. bolts or quick-change mounting configuration, the jaws are secured to the chuck assembly. Upon completion of the job, the jaws are stored or otherwise replaced for the subsequent machining job.

It should be appreciated that as a result of the precise placement of the jaws onto the chuck assembly, and secure mounting means, no additional adjustment of the jaws are necessary.

While the description disclosed herein is somewhat directed to diaphragm chuck assemblies, it should be appreciated that the mounting configuration and quick-change features may be used in different types of chuck assemblies.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only four of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A diaphragm chuck assembly, the assembly including:
a chuck body adapted for rotation about an axis;
a diaphragm mounted to the chuck body, the diaphragm including a plurality of mounting structures attached or formed on an exterior surface of the diaphragm and radially disposed with respect to the axis;
an actuator adapted for engagement with the diaphragm, the actuator configured for movement along the axis and between an engagement position and disengagement position; and
work engaging jaws removably attached to the plurality of mounting structures, wherein the mounting structures and work engaging jaws include corresponding gears or teeth adapted to locate and secure the work engaging jaws to the diaphragm, and wherein upon axial movement of the actuator the central portion of the diaphragm moves inward or outward with respect to the chuck body thereby causing the work engaging jaws to engage and/or disengage a work piece.

2. The diaphragm chuck of claim 1, wherein the mounting structure includes a locating feature adapted for locating the corresponding gears or teeth of the mounting structure and work engaging jaws during joining of the same.

3. The diaphragm chuck of claim 2, wherein the locating feature comprises a locating pin extending from the diaphragm adapted to engage a corresponding hole in the work engaging jaws.

4. The diaphragm chuck of claim 3, wherein the mounting structure comprises a separate member mounted to the diaphragm.

5. The diaphragm chuck of claim 1, wherein removable attachment of the work engaging jaws to the mounting structures comprises one or more fasteners.

6. The diaphragm chuck of claim 1, wherein removable attachment of the work engaging jaws to the mounting structures is achieved through a cam configuration formed between the jaws and the chuck assembly.

7. The diaphragm chuck of claim 6, wherein cammed configuration comprises a dual stage cammed action formed of cammed surfaces having different angular degrees with respect to each other.

8. The diaphragm chuck of claim 6, wherein the cam configuration includes:
a rotatable threaded member mounted within the chuck assembly;
a bar member axially movable within the chuck assembly, the bar member including corresponding threads to the rotatable member, the bar member including one or more cammed surfaces;
a drive member axially movable within the chuck assembly, the drive member including one or more cammed surfaces configured to engage the cammed surfaces of the bar member at a first end and configured to engage one of the work engaging jaws at a second end,
wherein upon rotation of the treaded member the bar member axially moves to cause engagement of the cammed surfaces and axially move the drive member and cause locking of the work engaging jaw to the diaphragm.

9. The diaphragm chuck of claim 8, wherein the cam configuration further includes a plurality of paws configured to engage the drive member at a first end and the work engaging jaw at a second end.

10. The diaphragm chuck of claim 9, wherein the work engaging jaw includes an elongated member configured to engage an internal portion of the plurality of paws.

11. The diaphragm chuck of claim 9, wherein the work engaging jaw includes a cylindrical member configured to engage an external portion of the plurality of paws.

12. The diaphragm chuck of claim 8, wherein the rotatable threaded member includes an engagement feature for engaging a turning member.

13. The diaphragm chuck of claim 12, wherein the turning member is electronically controllable.

14. The diaphragm chuck of claim 12, wherein the turning member is manually controllable and extends to an external portion of the diaphragm chuck.

15. The diaphragm chuck of claim 1, wherein removable attachment of the work engaging jaws to the mounting structures is achieved through a threaded mounting configuration formed between the jaws and the chuck assembly.

16. The diaphragm chuck of claim 15, wherein the threaded configuration includes a threaded collar configured to engage threads formed about the mounting structure, the threaded collar also being configured to engage one of the work engaging jaws, wherein upon rotation of the collar engages the work engaging jaws and locks the jaw to the diaphragm.

17. The diaphragm chuck of claim 15, wherein the threads of the collar are internally formed and the threads of the mounting structure are externally formed.

18. The diaphragm chuck of claim 17, wherein the collar includes a lip member having a plurality of openings formed therein for receiving a plurality of corresponding lip members formed on the work engaging jaws, wherein upon rotation the collar the lip members of the collar and jaw overlap and wherein upon continued rotation of the collar the lip member applies to force to the lip member of the jaw to draw the jaw closer to the diaphragm, cause locking of the jaw to the diaphragm or both.

19. The diaphragm chuck of claim 18, wherein the threaded configuration further includes feature for controlling the amount of rotation of the collar.

20. The diaphragm chuck of claim 19, wherein the rotational control feature comprises a projection extending inwardly from the collar and a groove formed on an exterior portion of the mount structure for receiving the projection and limiting the rotational movement of the collar.
